(19) United States
(12) Patent Application Publication
(10) Pub. No.: US 2007/0127639 A1
(43) Pub. Date: Jun. 7, 2007

(54) Smart text telephone for a telecommunications system

(76) Inventor: Yi T. Huang, Vernon Hills, IL (US)

Correspondence Address: MOTOROLA, INC., 1303 EAST ALGONQUIN ROAD, IL01/3RD, SCHAUMBURG, IL, 60196, US

(21) Appl. No.: 11/294,303

(22) Filed: Dec. 2, 2005

(51) Int. Cl. H04M 11/00

(52) U.S. Cl. 379/88.13

(57) ABSTRACT

Systems, methods, and devices that support and automatically enable text (TTY) mode or voice mode for any incoming and outgoing calls are disclosed. In accordance with embodiments of the present invention, the ability to automatically enable or disable TTY mode for any calls to and from a telematics system is provided. For incoming calls, calling phone numbers with TTY devices are automatically recognized based on a comparison to numbers in a TTY table, and in instances of a match, the TTY mode is automatically enabled. For outgoing calls, the calls may be automatically connected to a pre-configured TTY service number. The automatic operation in either TTY mode or voice mode may be based on additional configurations and statuses. In some embodiments of the present invention, the systems, methods, and devices may be used in conjunction with a vehicle.

### FIELD OF THE INVENTION

The present invention is generally related to the field of telecommunications, and more particularly to systems, devices, and methods for voice and text communications using a text telephone (TTY) device.

### BACKGROUND OF THE INVENTION

A TTY device is an electronic device that allows users to type messages back and forth to one another instead of speaking and listening. TTY devices are particularly useful to persons who are hearing-impaired and/or speech-impaired; however, TTY devices may also be used by persons who are not hearing-impaired or speech-impaired.

A TTY device is typically used at each end of a conversation in order to communicate. To communicate, a person types on a keypad of the TTY device. Each character is transmitted by an electronic code called Baudot. The electronic code is sent from the transmitting TTY device to a receiving TTY device in the form of tones. The receiving TTY device transforms the tones back to letters on a display screen. The part of the conversation typed by the person at the transmitting TTY device may then be read on the display screen of the receiving TTY device.

A person without a TTY device can communicate with a person who has a TTY device by using the telecommunications relay service (TRS). With TRS, a third-party operator types the words spoken by the person without the TTY device, and sends the text to the TTY device of the other party. The person with the TTY device reads the text and can type back a response, which the TRS operator reads aloud to the party without the TTY device.

### BRIEF DESCRIPTION OF THE DRAWINGS

Embodiments of the inventive aspects of this disclosure is best understood with reference to the following detailed description, when read in conjunction with the accompanying drawings, in which:

FIG. 1 depicts a block diagram of a TTY device coupled to a telematics system;

FIG. 2 depicts a flow diagram corresponding to a process for configuring a TTY table;

FIG. 3 depicts a flow diagram corresponding to a process for receiving incoming calls; and

FIG. 4 depicts a flow diagram corresponding to a process for sending outgoing calls.

### DETAILED DESCRIPTION OF THE INVENTION

Previous attempts to incorporate a TTY device into a telecommunications system have suffered from a number of shortcomings. For example, a telephone may be shared by different members of a household having different needs, such as a husband who communicates using a TTY terminal and a wife who communicates by speaking and listening. Previous telecommunications systems do not provide flexibility for accommodating both TTY-device users and non-TTY-device users who may share a telephone. In addition, previous telematics systems do not provide for the capability of automatically recognizing an incoming call from a TTY device. Furthermore, previous telecommunications systems do not provide for the capability of automatically processing a call in voice mode or TTY mode, based on whether a TTY device is connected to the telecommunications system and enabled.

The present invention provides for systems, methods, and devices that support and automatically enable TTY mode or voice mode for incoming and outgoing calls to and from a local terminal, depending on configurations and TTY device status. In accordance with certain embodiments of the present invention, the ability to automatically enable and disable TTY mode for a call is provided. In TTY mode, a TTY device receives signals in Baudot code and converts them to text on a display screen. Characters typed into a keypad are converted into Baudot code and transmitted. In TTY mode, the tones representing Baudot code are sent and received along with voice signals. For incoming calls, calling phone numbers associated with TTY devices are automatically recognized based on a comparison to one or more previously stored numbers in a TTY table, and in instances of a match, the TTY mode is automatically enabled. For outgoing TTY calls, the calls may be automatically connected to a pre-configured designated TTY service number. The automatic operation in either TTY mode or voice mode may be based on additional configurations and statuses. TTY mode is supported for both analog and digital signals. The system for text and voice communications comprises a control unit including a controller and a cellular transceiver, communicably coupled to a TTY device comprising a keypad and a display. In certain embodiments the control unit may be integrated with the TTY device, while in other embodiments, the control unit may be separate from the TTY device. Upon detecting an incoming call from a TTY number, the system automatically enables TTY mode.

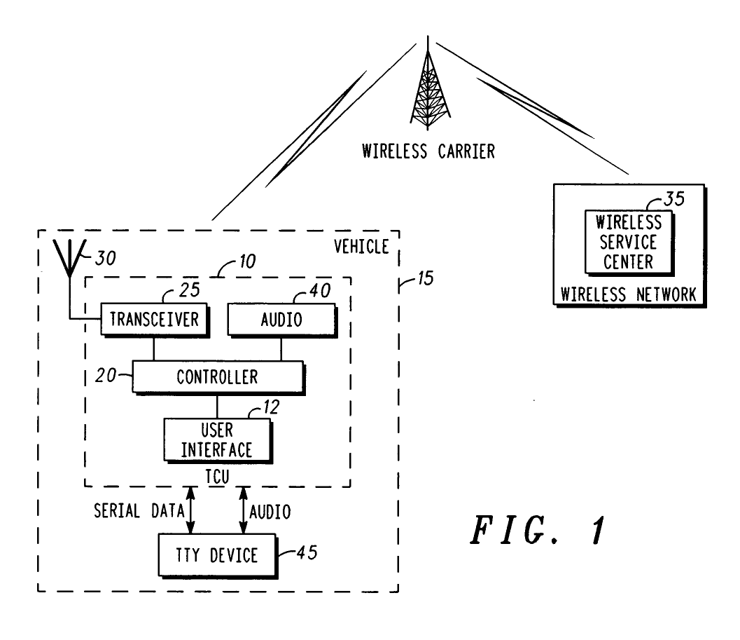

Reference is now made to FIG. 1, which depicts a block diagram of an exemplary system for voice and text communications. The system comprises a telematics control unit (TCU) 10. In one embodiment of the present invention, the TCU 10 may be housed in a vehicle 15. The vehicle 15 may comprise, for example, an automobile, truck, bus, subway, train, boat, or other type of vehicle. While the embodiment depicted in FIG. 1 is described in connection with a vehicle 15, it should be noted that the vehicle 15 is optional, and other embodiments of the present invention may be practiced without any vehicle 15. Indeed, the present invention may be implemented in any of a variety of environments, such as a home, business, school, outdoors, etc.

The TCU 10 enables two-way communication (e.g., two-way audio and data communication) between an occupant of the vehicle 15 and another party at a remote terminal. The TCU 10 houses the basic electronic components for support of safety and security services, personal cellular telephony, input/output (I/O) interfaces 12, vehicle serial data buses, etc. The TCU 10 is controlled by various inputs, including the TCU's faceplate controls, remote mounted switches, voice inputs, etc. In the vehicular telematics system context, the TCU 10 is also sometimes referred to as a vehicle communications platform (VCP). In practice, the TCU 10 may comprise or couple to additional components, such as a global positioning system (GPS) module, voice recognition module, hands-free module, power supply, modem, cellular telephone, etc., which are not shown in FIG. 1 for purposes of simplicity.

The TCU 10 comprises a controller 20. An example of a suitable controller is the MOTOROLA® MGT5200 microprocessor. It will be appreciated by those of skill in the art that other suitable models of a controller may be used, and the present invention is not limited to any particular model. The controller 20 may be included, for example, in a network access device (NAD) or in a cellular telephone or both. A TCU application is included in the controller 20 and is the principal controlling software running on the controller 20.

The TCU 10 further comprises a cellular transceiver 25. Like the controller 20, the cellular transceiver 25 may also be included, for example, in the NAD or in a cellular telephone or both. An example of a suitable cellular transceiver 25 is the QUALCOMM® MSM5105 chipset plus NAD software. It will be appreciated by those of skill in the art that other suitable models of a NAD may be used, and the present invention is not limited to any particular model. The cellular transceiver 25 may operate according to an analog wireless communication protocol such as the advanced mobile phone system (AMPS). In addition, the cellular transceiver 25 may operate according to a digital wireless communication protocol such as a code division multiple access (CDMA) protocol. Furthermore, the cellular transceiver 25 may operate according to a time division multiple access (TDMA) protocol. Moreover, the cellular transceiver 25 may operate according to one of several types of bearer services to transmit data between the TCU 10 and a remote station, such as global system for mobile communications (GSM), universal mobile telecommunications service (UMTS), general packet radio service (GPRS), wireless application protocol (WAP), short message service (SMS), circuit switched data service (CSD), high-speed circuit switched data service (HSCSD), or other wireless communication service.

The cellular transceiver 25 is coupled to an antenna 30. The antenna 30 may be for example, a cellular antenna for sending and receiving radio frequency (RF) signals to and from a remote station such as a wireless service center 35 via a wireless carrier. The antenna 30 may also be a combined antenna comprising an integrated GPS and cellular antenna.

The TCU 10 further comprises an audio module 40. The audio module 40 comprises an audio codec, logic, and clocks. The audio module 40 receives analog audio signals from a microphone in the vehicle 15. The audio module sends analog audio signals to a speaker in the vehicle 15. The speaker actually represents what would likely in a real commercial embodiment comprise a plurality of speakers (e.g., the vehicle's stereo speakers), although a dedicated telematics speaker may be used as well.

In accordance with the present invention, a TTY device 45 comprising a keypad and a display is communicably coupled to the TCU 10 via wireless or wireline connection. In a vehicular context, the TTY device 45 may be a detachable, portable TTY device in the vehicle 15, or the TTY device 45 may be integrated with the TCU 10 in vehicle 15. The TTY device 45 can be communicably coupled to the TCU 10 in a manner such as that described in co-pending and commonly owned application Ser. No. 10/376,917 filed on Feb. 28, 2003, the contents of which are incorporated herein. The vehicle communication system of application Ser. No. 10/376,917 includes an external interface embedded in a vehicle, capable of receiving a first set of teletype signals from a portable TTY device and capable of sending a second set of teletype signals to the portable TTY device. In embodiments of the present invention in which vehicle 15 is not included, the TTY device 45 may be communicably coupled via wireless or wireline connection to a cellular telephone, landline telephone, or other device for telephony. In addition, the TTY device 45 may be integrated with the TCU 10 in a single telecommunications device, such as a cellular telephone, personal digital assistant (PDA), pager, landline telephone, personal computer, or other telecommunications device.

In accordance with the present invention, the ability to automatically support and switch between TTY mode and voice mode for any calls is provided. In voice mode, audio signals are received and transmitted, and the ability to send and receive signals in Baudot code and convert to and from text is disabled. In TTY mode, signals in Baudot code are received and transmitted and converted to and from text, and tones representing the Baudot codes are mixed with voice signals. For incoming calls, calling telephone numbers associated with TTY devices are automatically recognized based on a comparison to information in a TTY table, and in instances of a match, the TTY mode is automatically enabled. For outgoing TTY calls, the calls may be directly connected to a designated pre-configured service center number with a TTY device. The automatic processing of a call in TTY mode or voice mode may be based on additional configurations and statuses.

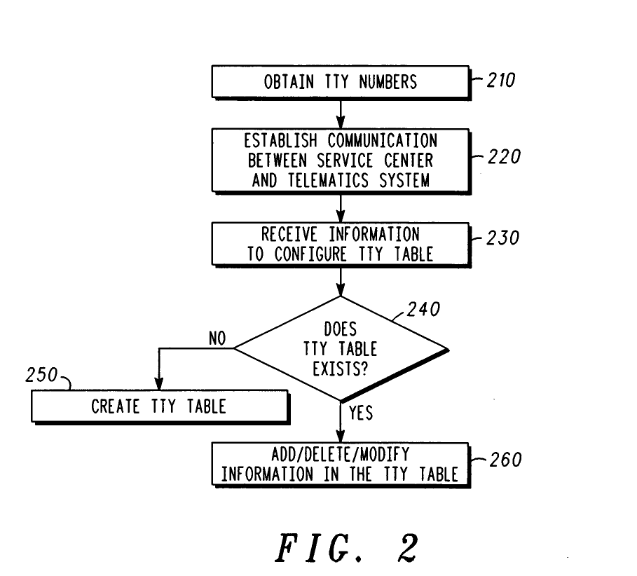

Reference is now made to FIG. 2, which depicts a process flow diagram for configuring a TTY table in accordance with the present invention. In step 210, one or more telephone numbers associated with a TTY device is obtained. In some embodiments, the TTY table may be configured over-the-air. The user may dial a number and pass data to the TCU via a service provider. In addition, the user may input one or more caller IDs into a service provider's database via the service provider's web site. The service provider, such as OnStar, may also input one or more caller IDs, such as the service provider's toll-free TTY number. Alternatively, the user may send information to the TCU by a wireless or wireline connection to a device in the vehicle, such as a laptop, cellular telephone, PDA, etc. Thus, the information may be sent over the air, via PC, or via any serial tools that could be connected to the TCU.

In addition to TTY numbers associated with TTY devices, other information may be added to the TTY table or linked to the phone numbers in the table, such as a name (e.g., “Mary Smith”), a nickname (e.g., “Grandma”), or an image (e.g., a picture) of a person associated with a particular TTY number. In addition to text and images, a voice tag may be linked to a phone number. The size and content of the TTY table may be configured as desired.

In step 220, communication is established from the service center to the telematics system. For example, an inbound call from the service center to the telematics system may be made. Or, a call from the telematics system to the service center may be made.

In step 230, information comprising the TTY numbers is received by the telematics system. Next, the information is stored in the telematics control unit as, for example, a TTY table. The size and content of the table are configurable. If a TTY table is not yet existing, a TTY table is created in step 250. If a TTY table already exists, then it is updated by adding, deleting, or changing the entries in the TTY table in step 260.

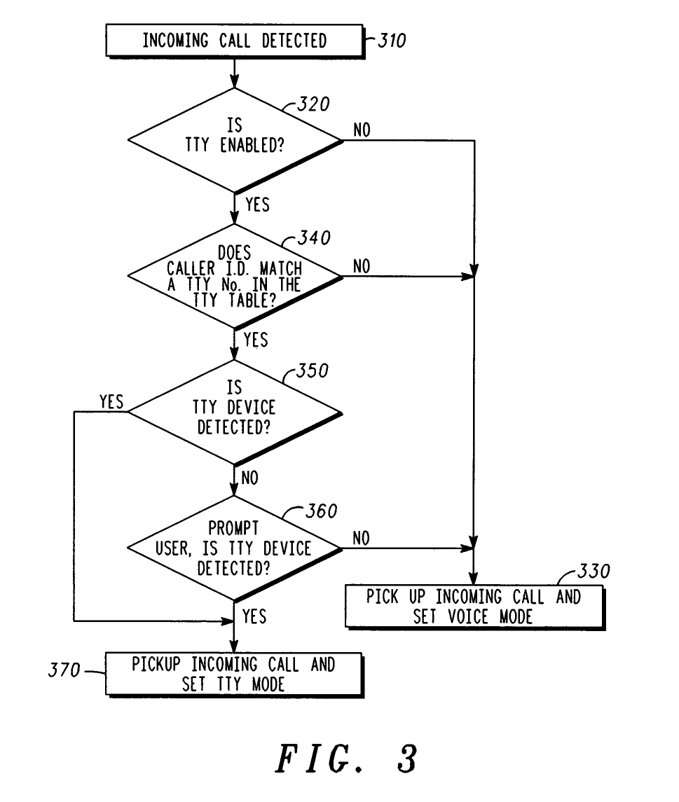

Reference is now made to FIG. 3, which depicts a process flow diagram for processing an incoming call in accordance with the present invention. The following operations described in connection with FIG. 3 need not be executed in the order described, as they may be executed in a different sequence consistent with the principles of the present invention.

In step 310, an incoming call is detected by the telematics system. In decision 320, it is determined whether the telematics system is TTY enabled. For example, the TTY feature may be available only with a paid subscription, and a check may be made to determine if the telematics system owner has subscribed to the TTY feature.

If the system is not TTY enabled, then the incoming call is automatically processed as a voice call in step 330. If the system is TTY enabled, then process flow continues to decision 340.

In addition, it may optionally be determined whether the vehicle is in motion. As an optional safety feature, if the vehicle is in motion, then the incoming call may be automatically processed as a voice call in step 330; otherwise, process flow continues to decision 340.

In decision 340, the caller ID information, such as the caller's phone number or name, is compared to the information in the TTY table. If a match is not found, then the call is automatically processed as a voice call in step 330. In addition, if the TTY table has no information, then the call is automatically processed as a voice call in step 330. If a match is found, then process flow continues to decision 350.

In decision 350, it is determined whether a TTY device is connected to the telematics unit, and whether the TTY device is powered on. If a TTY device is not detected or not powered on, then the user is prompted to connect and/or power on the TTY device in step 360. For example, a voice prompt may be used to advise the user to connect the TTY device or power on the TTY device. In addition, a message may be displayed on a display screen which advises the user to connect the TTY device or power on the TTY device. If the user fails to do so after a specified timeout period, then the call is automatically processed as a voice call in step 330. If a TTY device is detected, then the call is automatically processed in TTY mode using Baudot code in step 370.

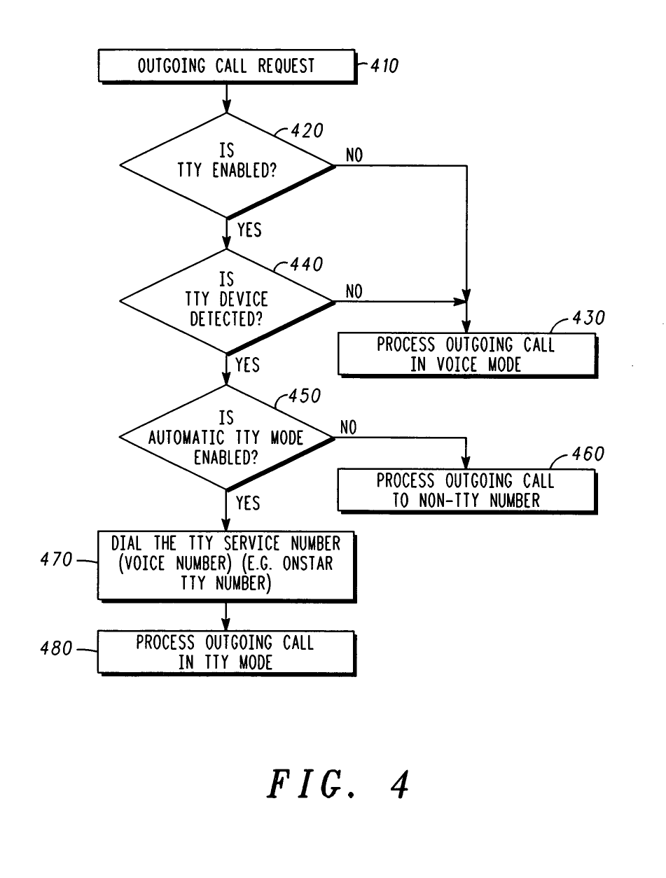

Reference is now made to FIG. 4, which depicts a process flow diagram for processing an outgoing call in accordance with the present invention. The following operations described in connection with FIG. 4 need not be executed in the order described, as they may be executed in a different sequence consistent with the principles of the present invention.

In step 410, an outgoing call is requested by a local terminal. For example, a button may be pressed in the vehicle to trigger an outbound call to the service center. Such a button can be that typically used in a vehicle-based telematics system such as a “push-to-talk” button or an “OnStar®” button.

In decision 420, it is determined whether the telematics system is TTY enabled. For example, the TTY feature may be available only with a paid subscription, and a check may be made to determine if the user has subscribed to the TTY feature.

If the system is not TTY enabled, then the call is automatically processed in voice mode in step 430. If the system is TTY enabled, then process flow continues to decision 440.

In decision 440, it is determined whether a TTY device is connected to the telematics unit, and whether the TTY device is powered on. If a TTY device is not detected or not powered on, then the user may be prompted to connect and/or power on the TTY device. For example, a voice prompt may be used to advise the user to connect the TTY device or power on the TTY device. In addition, a message may be displayed on a display screen which advises the user to connect the TTY device or power on the TTY device. If the user fails to do so after a specified timeout period, then the call is automatically processed as a voice call in step 430.

In addition, it may optionally be determined whether the vehicle is in motion, as an added safety feature. If a TTY device is not detected or not powered on (or optionally, if the vehicle is in motion), then the call is automatically processed in non-TTY (voice) mode in step 430. If a TTY device is detected (and optionally the vehicle is not in motion), then process flow continues to decision 450.

In decision 450, it is determined whether automatic TTY mode is enabled. In other words, it is determined whether the system is configured to call an automatic TTY service number. If an automatic TTY number is not configured, the TCU calls a non-TTY number, typically the regular service center number (which is normally a data number). Once the call is connected, a TTY device present status is included in the vehicle identification message to the service call center. The call center routes the call to the phone line with TTY device support and sends back a request to the TCU to switch the call to voice mode. Once the call is switched to voice mode, the TCU automatically enters the TTY mode (using Baudot code) in step 460.

If automatic TTY mode is enabled, process flow continues to step 470. A service call is made to a specific TTY number (e.g., the OnStar® TTY number) corresponding to the service type. For example, each service call button could have a specific phone number associated therewith. TTY mode is automatically enabled once the call is connected in step 480.

It should be understood that the inventive concepts disclosed herein are capable of many modifications. To the extent such modifications fall within the scope of the appended claims and their equivalents, they are intended to be covered by this patent.

What is claimed is:

1. A method for voice and text communications, the method comprising:
receiving at a local terminal a call from a remote terminal;
identifying a phone number of the remote terminal;
determining whether the phone number is associated with a text telephone device; and
processing the call in a text telephone mode if the phone number is associated with a text telephone device, else processing the call in a voice mode.

2. The method of claim 1, wherein the act of determining whether the phone number is associated with a text telephone device comprises comparing the phone number to one or more previously stored phone numbers.

3. The method of claim 2, wherein an image is linked to each of the previously stored phone numbers.

4. The method of claim 2, wherein a name is linked to each of the previously stored phone numbers.

5. The method of claim 2, wherein a voice tag is linked to each of the previously stored phone numbers.

6. The method of claim 1, wherein the local terminal is located in a vehicle.

7. The method of claim 6, further comprising the act of disabling the text telephone mode if the vehicle is in motion.

8. The method of claim 1, further comprising the act of detecting whether a text telephone device is coupled to the local terminal.

9. The method of claim 8, further comprising the act of sending a prompt to connect the text telephone device to the local terminal, if the text telephone device is not coupled to the local terminal.

10. The method of claim 8, further comprising the act of sending a prompt to power on the text telephone device, if the text telephone device is not coupled to the local terminal.

11. A method for voice and text communications, the method comprising:
receiving a request to make a call from a local terminal;
determining whether the local terminal is text telephone enabled;
determining whether the local terminal is pre-configured to call a designated text telephone number; and
calling the designated text telephone number in text telephone mode if the local terminal is pre-configured to call a designated text telephone number, else calling a non-text-telephone number in voice mode.

12. The method of claim 11, further comprising the act of processing the call in voice mode if a text telephone device is not coupled to the local terminal.

13. The method of claim 11, further comprising the act of sending a prompt to connect the text telephone device to the local terminal if a text telephone device is not coupled to the local terminal.

14. The method of claim 11, further comprising the act of sending a prompt to power on the text telephone device if a text telephone device is not coupled to the local terminal.

15. The method of claim 11, wherein the local terminal is located in a vehicle.

16. The method of claim 15, further comprising the act of disabling text telephone mode if the vehicle is in motion.

17. A system for voice and text communications, the system comprising:
a control unit comprising a controller and a cellular transceiver coupled to the controller; and
a text telephone device comprising a display and a keypad;
wherein the text telephone device is communicably coupled to the telematics control unit; and
wherein the control unit is configured to automatically enable text telephone mode upon detecting an incoming call from a text telephone number.

18. The system of claim 17, wherein the control unit comprises a means for comparing a phone number of the incoming text telephone call to one or more previously stored phone numbers.

19. The system of claim 17, wherein the control unit is configured to automatically dial a text telephone number.

20. The system of claim 17, wherein the control unit is a telematics control unit located in a vehicle.
